(19) United States
(12) Patent Application Publication
(10) Pub. No.: US 2024/0241487 A1
(43) Pub. Date: Jul. 18, 2024

(54) METHOD AND SYSTEM FOR CONTROLLING A PRODUCTION SYSTEM

(71) Applicant: Siemens Aktiengesellschaft, München (DE)

(72) Inventors: Stefan Depeweg, Berlin (DE); Kai Heesche, München (DE); Markus Kaiser, Cambridge (GB)

(21) Appl. No.: 18/562,370

(22) PCT Filed: May 10, 2022
(86) PCT No.: PCT/EP2022/062693

§ 371 Date: Nov. 20, 2023

(30) Foreign Application Priority Data
May 28, 2021 (EP) 21176519.3

(51) Int. Cl. G05B 13/04; G05B 13/02

(52) U.S. Cl. CPC G05B 13/048; G05B 13/027

(57) ABSTRACT

A plurality of test data sets include: a first design data set specifying a design variant of a product; and first target values, which quantify target variables of the design variant which are to be optimized and ranked. Furthermore, a plurality of design evaluation modules for predicting target values on the basis of design data sets is provided. For each of the design evaluation modules, a second ranking of the first design data sets with respect to the predicted target values and a deviation of the second ranking from the first ranking are then determined. One design evaluation module is then selected in accordance with the determined deviations. Furthermore, a plurality of second design data sets is generated, and are predicted by the selected design evaluation module. A target-value-optimized design data set is then derived from the second design data sets and is output for the manufacturing of the product.

### CROSS-REFERENCE TO RELATED APPLICATIONS

This application claims priority to PCT Application No. PCT/EP2022/062693, having a filing date of May 10, 2022, which claims priority to EP Application No. 21176519.3, having a filing date of May 28, 2021, the entire contents all of which are hereby incorporated by reference.

### FIELD OF TECHNOLOGY

The following relates to a method and system for controlling a production system.

### BACKGROUND

For producing complex technical products, such as robots, motors, turbines, turbine blades, internal combustion engines, tools, motor vehicles or their components, computer-aided design systems are becoming increasingly commonly used. By these design systems, design data is usually generated, which specifies a product to be manufactured in detail and which can be used to control production systems for the manufacture of the specified product.

In order to optimize desired product characteristics, it is often sought to optimize the design data for the product automatically. The product characteristics or target characteristics can relate to performance, functionality, yield, speed, weight, runtime, precision, failure rate, resource consumption, efficiency, pollutant emissions, stability, wear, service life, a physical property, a mechanical property, a chemical property, an electrical property, a magnetic property, a secondary condition to be observed, or other target variables of the product.

In order to optimize target variables for a product, multidimensional optimization methods, so-called MDO methods (MDO: Multi Dimensional Optimization) can be used. These MDO methods typically simulate a large number of design variants of the product specified by design data and specifically select those that optimize the simulated target variables.

However, such simulations are often considerably computationally intensive, in particular since a large number of design variants often need to be evaluated. In order to reduce the required computational complexity, so-called surrogate models are often used, which are trained, in particular by machine learning methods, to predict relevant simulation results or target variables without detailed simulation. However, such surrogate models often exhibit low or variable accuracy.

### SUMMARY

An aspect relates to a method and a system for controlling a production system, which allow for more efficient design optimization.

To control a production system for producing a product optimized with respect to multiple target values, a plurality of test datasets is read in, each of which comprises a first design dataset specifying a design variant of the product and the target values of that design variant quantifying first target values. Optimizing as used here and in the following is also understood as an approximation to an optimum. With respect to the first target values, a first ranking of the first design datasets is determined. Also, multiple design evaluation modules for predicting target values on the basis of design datasets are provided. The design evaluation modules predict target values for the first design datasets. For each design evaluation module, a second ranking of the first design datasets with respect to the predicted target values and a respective deviation of the respective second ranking from the first ranking are then determined. One design evaluation module is then selected depending on the determined deviations. Also, a plurality of second design datasets is generated, for which second target values are predicted by the selected design evaluation module. Depending on the second target values, a target-value-optimized design dataset is then derived from the second design datasets and output to produce the product.

To implement the method according to embodiments of the invention, a system for controlling a production system, a computer program product (non-transitory computer readable storage medium having instructions, which when executed by a processor, perform actions) and a machine-readable, non-volatile, storage medium are provided.

In embodiments, the method according to the invention and the system according to the invention can be embodied or implemented, for example, by one or more computers, processors, application specific integrated circuits (ASIC), digital signal processors (DSP) and/or so-called Field Programmable Gate Arrays (FPGA).

Embodiments of the invention, in particular such design evaluation modules can be selected for design optimization, which reproduce a ranking of design datasets derived from predefined data as accurately as possible. Such design evaluation modules can thus be used to recognize a target-value-optimized design dataset relatively reliably as such or to distinguish it from less optimal design datasets. In particular, even a design evaluation module that systematically mis-estimates with regard to the predicted target values can nevertheless be applied, provided that it only reproduces the actual ranking as well as possible.

According to an embodiment of the invention, machine learning modules can be provided as design evaluation modules, which have been trained, by training datasets that are different from the test datasets, to reproduce corresponding training target values on the basis of a training design dataset. Such trained machine learning modules usually require considerably fewer computing resources in their application than detailed simulation models.

Nevertheless, simulation modules can be provided as design evaluation modules, which on the basis of a design dataset specifying a design variant, predict the target values of that design variant. In this way, by embodiments of the invention, simulation modules can also be evaluated with regard to their accuracy in the prediction of rankings.

According to an embodiment of the invention, a respective design evaluation module for predicting target values for a respective first design dataset can output a statistical distribution of these target values in each case. For this purpose, each design evaluation module can implement a Bayesian neural network and/or a Gaussian process. Such a statistical distribution can be specified in particular by a mean, a median, a variance, a standard deviation, an uncertainty figure, a reliability figure, a probability distribution, distribution type, and/or curve specification of the target values. Based on the respective statistical distribution, a respective target-value sample can then be selected, in particular randomly. This allows the respective second ranking with respect to the selected target-value samples to be determined. Furthermore, the selected target-value samples, the determined second rankings and/or the determined deviations can be aggregated over multiple iterations of method step e) for the selection of a design evaluation module. The aggregation can include an averaging, integration and/or forming a minimum, a maximum, a quantile and/or percentile. By taking into account statistical distributions of the target values, their respective uncertainty can be estimated. In this way, more robust or reliable design variants can be selected.

According to a further embodiment of the invention, for determining the first and/or the respective second ranking for the first design datasets, a Pareto optimization can be performed using the target variables as Pareto target criteria. As part of this, a Pareto front can be determined. For each first design dataset, a respective distance, e.g., a Euclidean distance, from the Pareto front can then be determined. This allows the first and/or second ranking of the first design datasets to be determined according to their distance from the Pareto front. In particular, a smaller distance can be assigned a higher rank in the ranking than a larger distance. In this way, multiple independent target variables can be considered in a natural way in determining a ranking of design datasets. In addition, in many cases, the above procedure scales straightforwardly with the number of target variables.

According to a further embodiment of the invention, the deviation of the respective second ranking from the first ranking can be determined by a Kendall-tau metric.

The Kendall-tau metric can be weighted for this purpose. In particular, when the Kendall-tau metric is used a first design dataset with a smaller distance from the Pareto front can be weighted higher than a first design dataset with a greater distance from the Pareto front. In this way, better designs can be weighted more highly than poorer designs in the comparison of the rankings. This is desirable to the extent that the ranking of the best or near best designs is ultimately decisive for the selection of the target-value-optimized design dataset.

### BRIEF DESCRIPTION

Some of the embodiments will be described in detail, with reference to the following figures, wherein like designations denote like members, wherein:

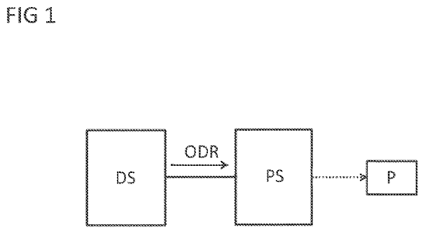

FIG. 1 shows a design system being used for controlling a production system for producing a product;

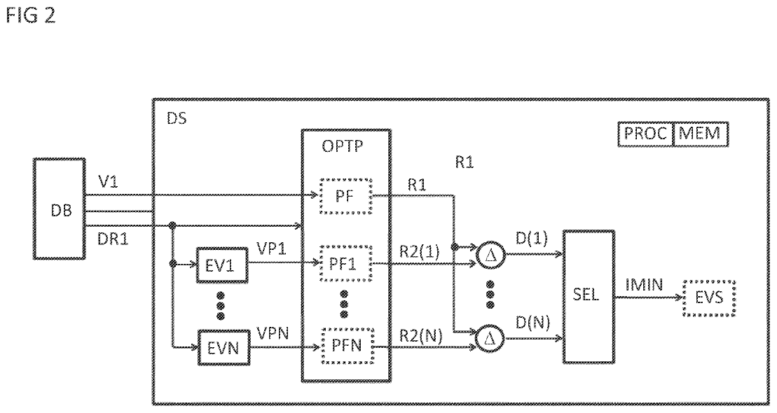

FIG. 2 shows a design system according to embodiments of the invention in a configuration phase;

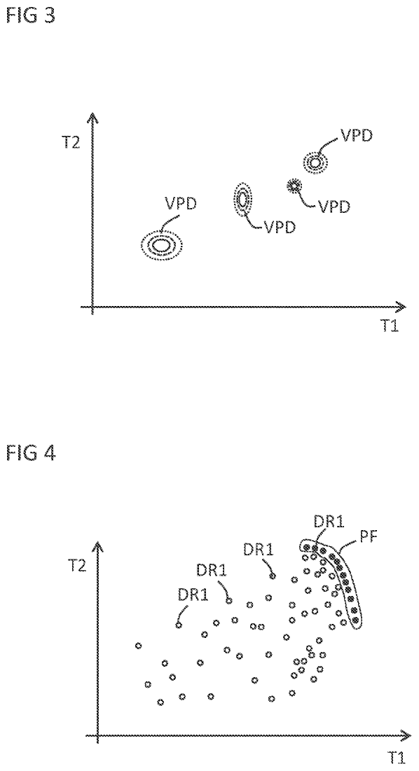

FIG. 3 shows predicted distributions of target values;

FIG. 4 shows a determination of a Pareto front for design datasets; and

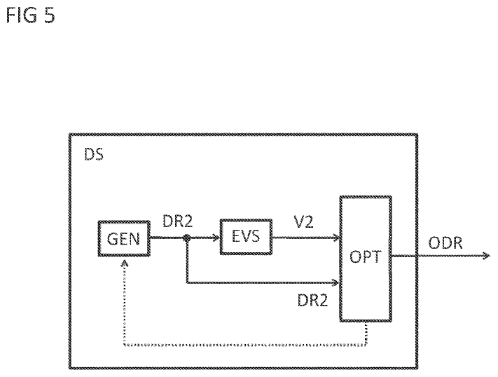

FIG. 5 shows the design system according to embodiments of the invention in an application phase.

### DETAILED DESCRIPTION

FIG. 1 shows a schematic representation of a design system DS coupled to a production system PS. The design system DS is used for the computer-aided design of a product P optimized with respect to multiple target variables and for controlling the production system PS in order to produce the product P. The production system PS may comprise a manufacturing plant, a robot, a machine tool and/or other devices for producing or processing the product P or a component thereof based on design data. The product P produced can be a motor, a robot, a turbine blade, a wind turbine, a gas turbine, a motor vehicle or another technical structure or component of these products.

A particular design or design variant of the product P to be produced is specified by design data in the form of a respective design dataset. Such a design dataset may specify in particular a geometry, a structure, a property, a production step, a material and/or a component of the product P.

According to embodiments of the invention, the design system DS is intended to be capable of largely automatically generating a realistic design dataset ODR which is optimized with respect to multiple predefined target variables for the product P. In particular, the target variables can relate to performance, functionality, yield, speed, quality, weight, runtime, precision, failure rate, resource consumption, efficiency, vibration tendency, stiffness, heat conduction, aerodynamic efficiency, material fatigue, pollutant emissions, stability, wear, service life, a physical property, a mechanical property, a chemical property, an electrical property, a magnetic property and/or other design criteria or secondary conditions to be observed by the product P.

The design system DS generates such a target-value-optimized design dataset ODR and transfers it to the production system PS. Based on the target-value-optimized design dataset ODR, the production system PS is caused to produce a target-value-optimized product P consistent with the target-value-optimized design dataset ORD.

FIG. 2 illustrates a design system DS according to embodiments of the invention in a configuration phase. The design system DS has one or more processors PROC for implementing the method according to embodiments of the invention and one or more memories MEM for storing data to be processed.

It is intended that the configuration will enable the design system DS according to embodiments of the invention to evaluate design datasets as accurately as possible with respect to the target variables to be optimized for the product P. In particular, a predicted ranking of the design datasets based on the target values should reproduce a predefined actual ranking as accurately as possible. For this purpose, the design system DS assesses a plurality of design evaluation modules EV1, . . . , EVN with respect to their respective reproduction accuracy of these rankings.

The design evaluation modules EV1, . . . , EVN are implemented in the present exemplary embodiment by machine learning modules, for example artificial neural networks. The machine learning modules EV1, . . . , EVN are trained using known and evaluated training datasets to reproduce corresponding training target values, in particular in the form of a statistical distribution of target values, based on a training design dataset. For the training, training design datasets, for example in the form of vectors of design parameters for the product P, are fed to a machine learning module EV1, . . . , EVN as input data. The resulting output data of each machine learning module EV1, . . . , EVN is compared with the associated training target values, for example a vector of target values, and a deviation is minimized by the training of the respective machine learning module.

Training here is understood generally to mean an optimization of a mapping from input data to output data of a machine learning module. This mapping is optimized according to predefined criteria during a training phase. Possible criteria to be used are, for example, a prediction error in the case of prediction models, a classification error in the case of classification models, or in the case of control models, a success of a control action. As a result of the training, in particular, network structures of neurons of a neural network and/or weights of connections between the neurons can be adjusted or optimized in such a way that the predefined criteria are satisfied as fully as possible. The training can thus be understood as an optimization problem. A wide range of efficient optimization methods are available for such optimization problems in the field of machine learning. In particular, gradient descent methods, particle swarm optimizations and/or genetic optimization methods can be used.

In the present exemplary embodiment, the design evaluation modules EV1, . . . , EVN are implemented as so-called Bayesian neural networks. Bayesian neural networks can be understood, inter alia, as statistical estimators. As such, a Bayesian neural network predicts a statistical distribution VPD of target values instead of a point prediction. In this way, in addition to an estimation of the target values, information on their uncertainty is also obtained. Such statistical distributions can be characterized in particular by means and variances.

FIG. 3 illustrates such predicted statistical distributions VPD for different target variables T1 and T2, with respect to which the product P is to be optimized. The target variables T1 and T2 can be, for example, the weight and vibration tendency of a turbine blade. FIG. 3 illustrates a respective predicted statistical distribution VPD as a contour diagram of a probability density for a respective target value pair.

Efficient training methods for Bayesian neural networks can be found, for example, in the publication “Pattern recognition and machine learning” by Christopher M. Bishop, Springer 2011.

After the design evaluation modules EV1, . . . , EVN have been trained as described above, known and evaluated test datasets for testing the design evaluation modules EV1, . . . , EVN are read—as also illustrated in FIG. 2—from a database coupled to the design system DS. To avoid overfitting effects, the test datasets do not originate from the set of training datasets used for training. In the same way as the training datasets, the test datasets each comprise a first design dataset DR1 specifying a design variant of the product P, and first target values V1 quantifying target variables of that design variant.

The first design datasets DR1 with their respective assigned first target values V1 are fed into a Pareto optimizer OPTP of the design system DS. The Pareto optimizer OPTP is used to perform a Pareto optimization.

A Pareto optimization is a multi-criteria optimization in which multiple different target criteria, so-called Pareto target criteria, are taken into account independently. In the present exemplary embodiment, the target variables to be optimized form the Pareto target criteria. As a result of the Pareto optimization, a so-called Pareto front is determined.

FIG. 4 illustrates the determination of a Pareto front PF for the first design datasets DR1. In FIG. 4, the first design datasets DR1 are entered as circles into a coordinate system with the target variables T1 and T2 as coordinate axes, in each case according to the assigned target values. For reasons of clarity, only a few examples of the first design datasets DR1 are identified by a reference sign.

The Pareto front PF is formed by the solutions of a multi-criteria optimization problem for which one target criterion cannot be improved without degrading another target criterion. A Pareto front thus forms, to a certain extent, a set of optimal compromises. In particular, solutions not included in the Pareto front PF can still be improved with respect to at least one target criterion and can therefore be considered as sub-optimal.

In FIG. 4, the first design datasets DR1 of the Pareto front PF are illustrated by filled circles and the first design datasets DR1 that do not belong to the Pareto front PF are illustrated by unfilled circles. As can be seen from FIG. 4, the Pareto optimization proceeds in the direction of larger target values for the target variables T1 and T2. A wide range of efficient standard routines, in particular from machine learning, are available for such Pareto optimizations and for the respective determination of a Pareto front.

As indicated in FIG. 2, the Pareto optimizer OPTP determines a Pareto front PF for the first design datasets DR1 with respect to the first target values V1. Using the Pareto front PF, the distance from the Pareto front PF is then determined for each of the first design datasets DR1. For example, a Euclidean distance can be determined as the distance. The first design datasets DR1 are then sorted according to their distance from the Pareto front PF. This sorting creates a first ranking R1 of the first design datasets DR1. That is, the first ranking R1 orders the first design datasets DR1 according to their distance from the Pareto front PF, with a smaller distance corresponding to a higher rank than a larger distance. The first ranking R1 determined is used as a benchmark for the subsequently determined rankings.

According to embodiments of the invention, for each of the design evaluation modules EV1, . . . , EVN, a respective second ranking R2(1), . . . , R2(N) is additionally determined. For this purpose, the first design datasets DR1 are fed into a trained design evaluation module EV1, . . . , EVN. The respective design evaluation module EV1, . . . , EVN consequently returns a predicted statistical distribution of the target values for each first design dataset DR1. From each statistical distribution returned, a respective target-value sample VP1, . . . , VPN is then taken according to this respective statistical distribution. In this case, VP1 denotes the target-value sample drawn from the output of the design evaluation module EV1 and accordingly, VPN denotes the target-value sample drawn from the output of the design evaluation module EVN.

The target-value samples VP1, . . . , VPN are fed into the Pareto optimizer OPTP. The latter determines for each of the target-value samples VP1, . . . , VPN—as described above—a design evaluation module-specific Pareto front PF1, . . . , PFN of the first design datasets DR1. In addition, for each design evaluation module EV1, . . . , EVN and for each first design dataset DR1—as also described above—its distance from the respective Pareto front PF1, . . . , PFN is determined. Finally, for each design evaluation module EV1, . . . , EVN, in accordance with the determined distances a second ranking R2(1), . . . , R2(N) is determined as described above.

The second rankings R2(1), . . . , R2(N) are then compared with the first ranking R1. A deviation D(1), . . . , D(N) of the respective second ranking R2(1), . . . , R2(N) from the first ranking R1 is determined from this. The respective deviation D(i), i=1, . . . , N, is determined by a modified Kendall-tau metric KT, according to D(i)=KT(R2(i), R1), i=1, . . . , N. The Kendall-tau metric KT is modified such that higher ranks of the respectively compared rankings are weighted higher, for example with a factor of 1/(R+1), where R denotes a respective rank. A smaller value for the rank R corresponds to a higher rank in the respective ranking.

The deviations D(1), . . . , D(N) are fed into a selection module SEL of the design system DS. The selection module SEL is used to select the instance or instances of the design evaluation modules EV1, . . . , EVN that best or most closely reproduces or reproduce a ranking of the first design datasets DR1. For this purpose, the deviations D(1), . . . , D(N) are evaluated by the selection module SEL. In order to take the stochastic target-value characteristics into account, the above extraction of the target-value samples VP1, . . . , VPN and their further processing are repeated multiple times or at frequent intervals. The resulting deviations D(1), . . . , D(N) are then averaged over these repetitions. In addition to a mean or a median, a variance or a confidence interval of the deviations D(1), . . . , D(N) is also calculated.

Depending on the deviations D(1), . . . , D(N) fed in, the selection module SEL determines an index IMIN of the instance of the design evaluation modules EV1, . . . , EVN which on average has a smallest or at least a smaller deviation D(IMIN) than other instances of the design evaluation modules EV1, . . . , EVN. The design evaluation module selected by the index IMIN from the design evaluation modules EV1, . . . , EVN is referred to below as EVS.

Evidently, the selected design evaluation module EVS can reproduce a target-value-oriented ranking of design datasets better than other design evaluation modules EV1, . . . , EVN. In practice, it has been shown that a design evaluation module selected in this way can usually perform very robust evaluations of design datasets.

A corresponding application of the design system DS with the selected design evaluation module EVS is illustrated by FIG. 5. The design system DS has a generator GEN for generating synthetic, second design datasets DR2, which each specify a design variant of the product P to be optimized. The generation of the second DR2 design datasets can also be randomly induced, in particular, in order to open up previously unknown ranges of possible design variants. The second design datasets DR2 are fed by the generator GEN into the selected design evaluation module EVS and into an optimization module OPT of the design system DS.

As already described above, the selected design evaluation module EVS predicts second target values V2, each in the form of a statistical distribution, for a respective second design dataset DR2. Each statistical distribution can be defined in particular by a mean value and its uncertainty. The second target values V2 are fed by the selected design evaluation module EVS into the optimization module OPT. Based on the input data DR2 and V2, the optimization module OPT selects one or more of the second design datasets DR2 with the highest or at least with higher second target values V2 and/or with a lower uncertainty than other second design datasets DR2.

In particular, the dataset of the second design datasets DR2 which has a maximum weighted combination of the target values V2 and their uncertainties can be output as the target-optimized design dataset ODR Alternatively, or additionally, a target-value-optimized design dataset ODR can be interpolated from multiple second design datasets DR2 selected according to the above criteria.

The target-value-optimized design dataset ODR is finally output by the optimization module OPT and can be used, as described in connection with FIG. 1, to control the production system PS in order to produce the design-optimized product P.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for controlling a production system for producing a product optimized with respect to multiple target variables, wherein
a) reading in a plurality of test datasets, each having a first design dataset specifying a design variant of the product, and first target values quantifying the target variables of that design variant;
b) determining a first ranking of the first design datasets with respect to the first target values;
c) providing multiple design evaluation modules for predicting target values on the basis of design datasets;
d) predicting target values for each of the first design datasets by the design evaluation modules,
e) determining for each design evaluation module
a second ranking of the first design datasets with respect to the predicted target values,
determining a deviation of the respective second ranking from the first ranking,
f) selecting one design evaluation module depending on the determined deviations,
g) generating a plurality of second design datasets, for which second target values are predicted by the selected design evaluation module; and
h) depending on the second target values, deriving a target-value-optimized design dataset from the second design datasets and output to produce the product.

2. The method as claimed in claim 1, wherein machine learning modules are provided as design evaluation modules, which have been trained by training datasets to reproduce corresponding training target values based on a training design dataset, and that the test datasets are different from the training datasets.

3. The method as claimed in claim 1, wherein simulation modules are provided as design evaluation modules, which on the basis of a design dataset specifying one design variant, predict the target values of that design variant.

4. The method as claimed in claim 1, wherein each design evaluation module for predicting target values for a respective first design dataset outputs a statistical distribution of those target values, that a respective target-value sample is selected on the basis of the respective statistical distribution, that the respective second ranking is determined with respect to the selected target-value samples, and that the selected target-value samples, the determined second rankings and/or the determined deviations are aggregated over multiple iterations of method step e) for the selection of a design evaluation module.

5. The method as claimed in claim 4, wherein a respective statistical distribution is specified by a mean, a median, a variance, a standard deviation, an uncertainty figure, a reliability figure, a probability distribution, distribution type, and/or curve specification.

6. The method as claimed in claim 1, wherein to determine the first and/or second ranking
Pareto optimization is performed for the first design datasets using the target variables as Pareto target criteria, wherein a Pareto front is determined,
a distance from the Pareto front is determined for each first design dataset, and
the first and/or second ranking of the first design datasets is/are determined according to their distance from the Pareto front.

7. The method as claimed in claim 1, wherein the deviation of the respective second ranking from the first ranking is determined using a Kendall-tau metric.

8. The method as claimed in claim 7, wherein in the use of the Kendall-tau metric, a first design dataset with a smaller distance from the Pareto front is weighted higher than a first design dataset with a greater distance from the Pareto front.

9. The method as claimed in claim 1, wherein each design evaluation module comprises an artificial neural network, a Bayesian neural network, a recurrent neural network, a convolutional neural network, an autoencoder, a deep-learning architecture, a support vector machine, a data-driven trainable regression model, a k-nearest-neighbor classifier, a physical model and/or a decision tree.

10. A system for controlling a production system for producing a product optimized with respect to multiple target variables, configured for implementing a method as claimed in claim 1.

11. A computer program produce, comprising a computer readable hardware storage device having computer readable program code stored therein, said program code executable by a processor of a computer system to implement a method configured for implementing a method as claimed in claim 1.

12. A machine-readable storage medium having a computer program as claimed in claim 11.
